(19) United States
(12) Patent Application Publication
(10) Pub. No.: US 2011/0010475 A1
(43) Pub. Date: Jan. 13, 2011

(54) METHOD AND DEVICE FOR LOGGING PROCESS VARIABLES OF A DIGITAL FIELD DEVICE

(75) Inventors: Andreas Wahlmann, Meerbeck (DE); Heiko Kresse, Obernkirchen (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/832,535

(22) Filed: Jul. 8, 2010

(30) Foreign Application Priority Data
Jul. 8, 2009 (DE) 10 2009 032 229.9

(51) Int. Cl. G06F 13/42

(52) U.S. Cl. 710/105; 710/100

(57) ABSTRACT

A method and an electronic device are provided for logging process variables of a bus-controlled automation system in which process variables which are relevant to evaluation are buffered in at least one digital field device and are subsequently read, for the purpose of evaluation, by a central computer unit which is connected to the field device via a data bus. Process variable values which are relevant to evaluation are buffered in the field device in the form of a message, a plurality of equidistantly successive process variable values are recorded as messages, where the first process variable value is assigned a time stamp recorded for each message, and further process variable values are stored in further identical messages.

### RELATED APPLICATIONS

This application claims priority under 35 U.S.C. §119 to German Patent Application No. 10 2009 032 229.9 filed in Germany on Jul. 8, 2009, the entire content of which is hereby incorporated by reference in its entirety.

### FIELD

The present disclosure relates to a method and an electronic device for logging process variables of a bus-controlled automation system in which process variables which are relevant to evaluation are buffered in at least one digital field device and are subsequently read, for the purpose of evaluation, by a central computer unit which is connected to the field device via a data bus.

### BACKGROUND INFORMATION

The field of application of the present disclosure extends to industrial automation systems, such as process installations, packaging installations, mechanical production lines and the like, in which digital field devices, for example electromotive variable-speed drives or position controllers for valves, are operated, configured and monitored by a central control unit in a manner networked via a data bus. When monitoring the automation system, the digital field devices determine characteristic process variables which can be used to derive diagnostic information, for example. For this purpose, it is desirable for all process variables to be synchronously recorded.

DE 43 15 336 B4 discloses a generic method and an electronic device for logging process variables of a bus-controlled automation system. Process variable values (in the form of a temperature profile in this case) measured by the field device (a temperature sensor by way of example in this case) are supplied to an A/D converter in order to then be supplied in digitized form to a central computer unit via a transmission path, such as a data bus. The central computer unit then evaluates the received process variables by correcting the measured process variables, e.g., in this case, by approximating the temperature-dependent control characteristic curve of the electronics.

The change behavior of process variables is characterized in that each process variable sporadically changes its value independently of the remaining process variables. A rate of change which is usually high requires a correspondingly high sampling rate, such as 10 Hz. The change in one process variable can subsequently change other process variables. The change frequency is usually low compared with the rate of change, for example, less than 0.2 Hz. This means that all process variables generally remain stable over a relatively long period of time. The central computer unit which requests the process variables for evaluation purposes can operate at a sampling rate of 1 Hz or less using the existing bus connection. In this case, the frequency with which data are interchanged can vary by +1-30%. In addition, the volume of data which can be transmitted for each data interchange operation can also be limited to a maximum of 25 bytes per HART message, for example, on account of system engineering restrictions.

In known HART bus protocols and field devices associated therewith, process variables are first of all buffered in the field device for the purpose of logging, as is provided, for example, in the Fieldbus Foundation, Foundation Specification FF890, 4.9 Trend Objects. After recording has been concluded, all process variable values are then read by the central computer unit at a subsequent point in time via the data bus. This method is usually used for established tests with a clear time constraint. A disadvantage of this method is that the storage space in the field device and thus the quantity of process variable values which can be recorded are limited.

While the central computer unit is reading the data, the field device itself cannot store any new process variable values. This method therefore does not allow any so-called online logging.

As an alternative to this, a method is known for logging process variable values, in which the field device stores all process variable values at fixed intervals of time and transmits more than one value for each process variable with each communication. A disadvantage of this method is that the volume of data and thus the number of values which can be transmitted and the resolution thereof depend on the transmission speed of the bus protocol used. For example, a communication frequency of 1 Hz and a maximum volume of data of 25 bytes per second at a sampling rate of 10 Hz means that a maximum of two process variables, each with a resolution of 1 byte (0 . . . 255 or −127 . . . +127), can be transmitted. In addition, there is a difficulty of compensating for interference in the communication link.

The known techniques explained above reveal a drawback in that the sampling rate which can be achieved does not suffice to log process variables in many digital field devices such as position controllers, electrical drives, pressure transducers and flow transducers, for example.

### SUMMARY

An exemplary embodiment provides a method for logging process variables of a bus-controlled automation system. The exemplary method includes buffering, in at least one digital field device, process variables which are relevant to evaluation. The exemplary method also includes reading, in a central computer unit connected to the at least one field device, the buffered process variables to evaluate the buffered process variables. The buffering including buffering process variable values which are relevant to evaluation in the field device in the form of a message, and buffering a plurality of equidistantly successive process variable values as subsequent messages, where the first process variable value is assigned a time stamp which is recorded for each message, and further process variable values are stored in further identical messages.

An exemplary embodiment provides an electronic device for logging process variables of a bus-controlled automation system. The electronic device includes at least one digital field device having at least one memory unit configured to buffer process variables which are relevant to evaluation such that the buffered processed values are configured to be subsequently read, for the purpose of evaluation, by a central computer unit which is connected to the field device via a data bus. For buffering, the at least one memory unit is configured to record messages each comprising a time stamp and a sequence of equidistantly sampled process variable values.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a diagrammatic block diagram illustration of an electronic device for logging process variables according to an exemplary embodiment of the present disclosure;

FIG. 2 shows a graphical illustration of the temporal occurrence of process variable values according to an exemplary embodiment;

FIG. 3 shows a diagrammatic illustration of the storage of the process variable values in messages according to an exemplary embodiment;

FIG. 4 shows a flowchart for illustrating exemplary steps of a method during storage in accordance with an exemplary embodiment of the present disclosure; and

FIG. 5 shows a flowchart for illustrating exemplary steps of a method during data interchange in accordance with an exemplary embodiment of the present disclosure.

### DETAILED DESCRIPTION

Exemplary embodiments of the present disclosure provide a method and an electronic device for logging process variables of a bus-controlled automation system, which makes it possible to quickly transmit a plurality of process variable values recorded in a field device to a central computer unit with little technical complexity in a manner which meets the requirements.

According to an exemplary embodiment, the process variables which are relevant to evaluation are buffered in the field device in the form of a message, a plurality of equidistantly successive process variable values are buffered as messages, where the first process variable value of which is assigned a time stamp recorded for each message, and further process variable values are stored in further identical messages.

The messages are held in a memory unit in chronological succession, in such a manner that they are ready for retrieval, until they are read according to a communication service which is implemented in the central computer unit and is oriented to the at least one memory unit.

A high data throughput and a high data density for each message are advantageously achieved in this manner for quickly running processes. In this case, the single time stamp for each message refers directly to the first process variable value and indirectly to all process variable values in the same message via the equidistant spacing between the process variable values. The available limited bandwidth of the transmission channel is consequently used efficiently to transmit process variable values.

Another advantage of the present disclosure is that a low-redundancy data message which is suitable, for example, for use in field devices in power-limited circuits is provided with little computing power.

In accordance with an exemplary embodiment of the present disclosure, the memory unit is in the form of a ring memory which provides a discrete number of memory locations for messages containing process variable values. A ring memory is provided with a so-called write pointer and a read pointer. A write pointer points to that memory location of the ring memory which will be written to during the next writing operation.

On the other hand, a read pointer points to that memory location which will be read during the next reading operation. The algorithm for the write and read pointer increment is implemented in such a manner that there is a jump from the last memory location of the ring memory to the first memory location. The read pointer can be behind the write pointer in the temporal sequence. If the write pointer points to the memory location behind the read pointer, both pointers are incremented simultaneously, that is to say, the oldest data in the ring memory are overwritten if necessary.

Exemplary embodiments of the present disclosure use this functionality of a ring memory. Since a ring memory can be implemented in accordance with appropriate software recorded on a computer-readable recording medium (e.g., a non-volatile memory such as a ROM, a hard disk drive, optical memory, flash memory, etc.), the ring memory can be implemented easily. Adaptation to the use of a ring memory in a field device for buffering process variable values requires analogous adaptation of the central computer unit so that the latter is able to read such a ring memory.

In order to transmit the buffered process variable values from the ring memory unit to the central computer unit, another exemplary feature which improves the disclosure provides that, after a request message has been received from the central computer unit, the field device fills the response message returned by the field device in response with the process variable values stored in the ring memory unit when the request message contains a flag indicating that the previous response message was correctly received.

Another exemplary feature which improves the disclosure proposes that the memory locations of the ring memory unit in the digital field device are dimensioned in such a manner that all process variable values of the field device which are relevant to evaluation can be stored in said field device with an assigned time stamp. The number of memory locations required therefore depends on the requirement on the basis of the volume of data. This makes it possible to implement, by way of example, the dynamic storage according to the subject matter of the disclosure.

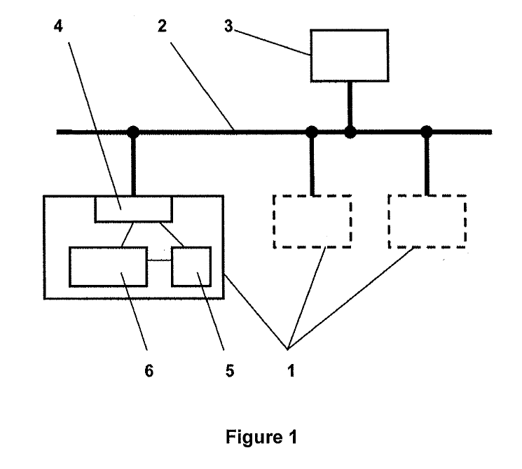

According to FIG. 1, an electronic device for logging process variables includes a digital field device 1 which is illustrated here by way of example as an intelligent actuating regulator for a valve of a process installation in this exemplary embodiment. The digital field device 1 is connected to a central computer unit 3 via a data bus 2.

The bus-controlled automation system is operated and monitored via the central computer unit 3. For connection to the data bus 2, the digital field device 1 has a communication interface 4. The digital field device 1 also includes a memory unit 5. The digital field device 1 dynamically stores process variable values in the form of the actual position of the actuating regulator, the applied operating pressure and the like as a message in the memory unit 5.

The central computer unit 3 can be configured to read these process variable values stored in the memory 5 according to a communication service which is implemented therein and is oriented to the memory unit 5. For example, according to an exemplary embodiment, the central computer 3 includes a processor (e.g., a CPU, a general-purpose processor, and/or an application specification integrated circuit (ASIC)) that can execute software recorded on a non-tangible computer-readable recording medium (e.g., a non-volatile memory such as a ROM, a hard disk drive, optical memory, flash memory, etc.) of the central computer 3 so that the central computer 3 is able to read memory units 5 of digital field devices 1 of the automation system at a high sampling rate.

In accordance with an exemplary embodiment of the field device 1, the memory unit 5 can be in the form of a ring memory. Each memory cell of the memory unit 5 is configured to record a message containing a series of chronologically successive process variable values. The memory cells of the memory unit 5 are examples of a non-tangible computer-readable recording recording medium (e.g., a non-volatile memory such as a ROM, a hard disk drive, optical memory, flash memory, etc.).

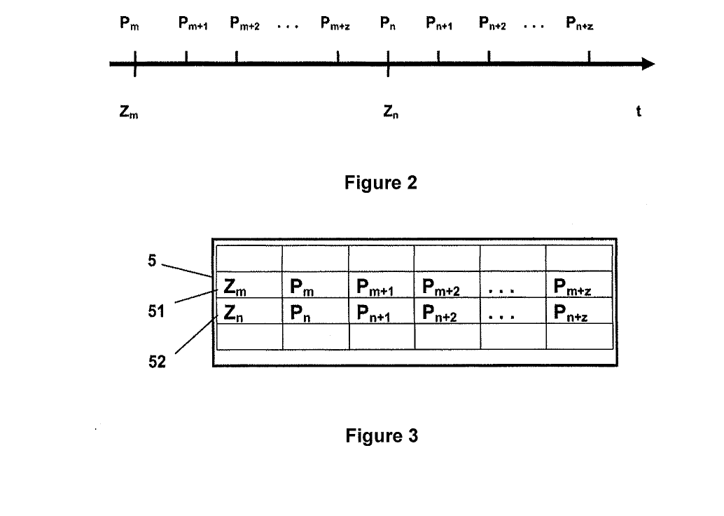

The sampling times of chronologically successive process variable values Pₘ to P_{n+z} are plotted on a timeline in FIG. 2. The process variable values Pₘ to P_{m+z} and Pₙ to P_{n+z} are recorded at equidistantly spaced-apart sampling times and are combined in groups to form respective z+1 process variable values Pₘ to P_{m+z} and Pₙ to P_{n+z} to in each message recorded in the memory unit 5. The respective first (e.g., oldest) process variable value Pₘ and Pₙ in each group is assigned a time stamp Zₘ and Zₙ. The sampling time of the respective first process variable value Pₘ and Pₙ in each message is thus documented by the respective time stamp Zₘ and Zₙ. As a result of the agreed equidistance of the sampling times and the chronologically successive recording, the sampling times of the other process variable values Pₘ₊₁ to P_{m+z}, and Pₙ₊₁ to P_{n+z} in each message necessarily result from the respective time stamp Zₘ and Zₙ and the position of the respective process variable value Pₘ₊₁ to P_{m+z} and Pₙ₊₁ to P_{n+z} inside the respective message.

FIG. 3 shows an excerpt from the memory array of the memory unit 5. In this case, two successive messages 51 and 52 are stored in adjacent memory cells. Using the same reference symbols for the same means, the message 51 comprises an initial time stamp Zₘ and z+1 equidistantly sampled process variable values Pₘ to P_{m+z}, the first element Pₘ of which was recorded at the time of the time stamp Zₘ. In the same format, the next message 52 has an initial time stamp Zₙ and z+1 equidistantly sampled process variable values Pₙ to P_{n+z}, the first element Pₙ of which was recorded at the time of the time stamp Zₙ.

According to an exemplary embodiment of the present disclosure, a new message 52 can be be recorded whenever one of the process variable values to be recorded has changed by more than an adjustable difference with respect to the last recorded process variable value P_{n+z} in the preceding message 51. This exemplary embodiment can be used in a particularly advantageous manner in processes which change slowly. A high degree of recording retrospectivity is advantageously achieved with little redundancy.

In accordance with an exemplary embodiment of the present disclosure, the successive messages 51 and 52 immediately follow one another, the process variable values Pₘ₊₁ and Pₙ having the same temporal interval as the process variable values Pₘ to P_{m+z} inside each message at the boundaries of the messages 51 and 52. This exemplary embodiment can be used in a particularly advantageous manner in processes which change quickly. Continuous recording is advantageously achieved in this case.

In accordance with an exemplary embodiment of the present disclosure, the number of process variable values in a message 51 and 52 and thus the length of the message are matched to the maximum capacity of a command of the respective transmission protocol on the data bus 2. HART, PROFIBUS or FOUNDATION field bus protocols, for example, can be used for this purpose, but the present disclosure is not limited thereto.

In accordance with an exemplary embodiment of the present disclosure, each process variable value Pₘ₊₁ to P_{m+z} and Pₙ₊₁ to P_{n+z} can include a plurality of simultaneously recorded physical and/or electrical variables.

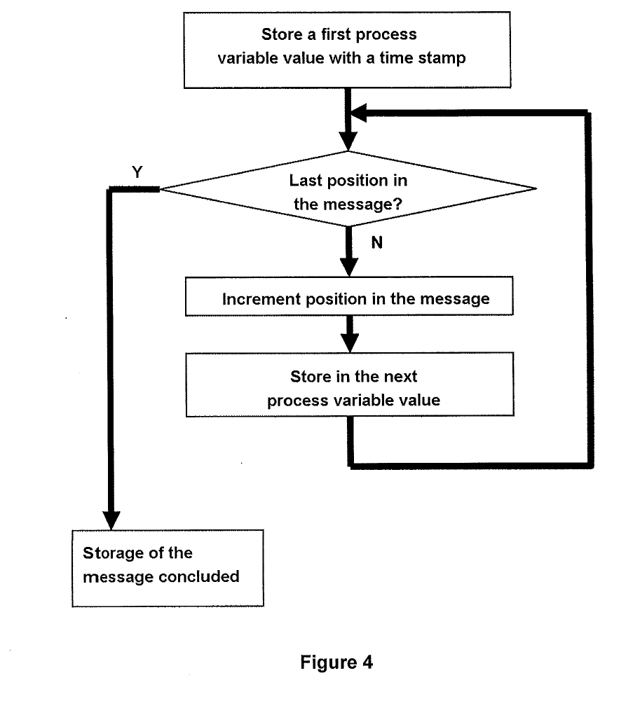

FIG. 4 shows a flowchart to illustrate exemplary process of recording the process variables. The respective first process variable value in a message is first of all stored together with a time stamp. As long as the last storage position which can be written to in the message has not yet been reached, the next storage position is actuated and the next process variable value is stored after being recorded. After the last storage position which can be written in the message has been reached, storage of the message is concluded.

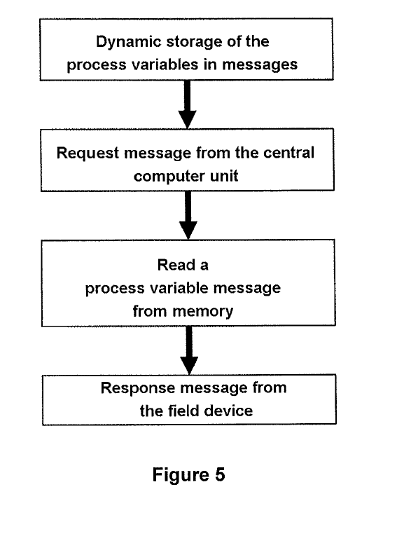

According to exemplary processes illustrated in FIG. 5, messages 51 and 52 which contain process variables and are dynamically stored in the field device 1 in the above manner are read by virtue of a request message to read the memory 5 being transmitted from the central computer unit 3 to the field device 1 via the data bus 2 which can be in the form of a HART bus, for example. The memory 5 is then read in the field device 1 and the results are sent back to the central computer unit 3 again, packaged in a response message, via the data bus 2.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Field device
2 Data bus
3 Central computer unit
4 Communication interface
5 Memory unit
51, 52 Message
Pₓ Process variable values
Zₓ Time stamp

What is claimed is:

1. A method for logging process variables of a bus-controlled automation system, the method comprising:
buffering, in at least one digital field device, process variables which are relevant to evaluation; and
reading, in a central computer unit connected to the at least one field device, the buffered process variables to evaluate the buffered process variables;
wherein the buffering comprises buffering process variable values which are relevant to evaluation in the field device in the form of a message, and buffering a plurality of equidistantly successive process variable values as subsequent messages, the first process variable value being assigned a time stamp which is recorded for each message, and further process variable values being stored in further identical messages.

2. The method as claimed in claim 1, comprising:
holding the messages in chronological succession in at least one memory unit of the at least one digital field device such that the held messages are ready for retrieval until the held messages are read according to a communication service which is implemented in the central computer unit and is oriented to the at least one memory unit.

3. The method as claimed in claim 1, comprising:
initializing the at least one memory unit by storing two memory locations with the process variable value which was sampled first and has the respective assigned time stamp.

4. An electronic device for logging process variables of a bus-controlled automation system, the electronic device comprising:
at least one digital field device having at least one memory unit configured to buffer process variables which are relevant to evaluation such that the buffered processed values are configured to be subsequently read, for the purpose of evaluation, by a central computer unit which is connected to the field device via a data bus,
wherein, for buffering, the at least one memory unit is configured to record messages each comprising a time stamp and a sequence of equidistantly sampled process variable values.

5. The device as claimed in claim 4,
wherein the central computer unit is configured to read the messages buffered in the at least one memory unit according to a communication service which is implemented in the central computer unit and is oriented to the at least one memory unit.

6. The device as claimed in claim 4, wherein the at least one memory unit is in the form of a ring memory.

7. The device as claimed in claim 4,
wherein the central computer unit is in the form of a personal computer via a HART, PROFIBUS or FOUNDATION field bus protocol.

8. The method as claimed in claim 2, comprising:
initializing the at least one memory unit by storing two memory locations with the process variable value which was sampled first and has the respective assigned time stamp.

9. The device as claimed in claim 5, wherein the at least one memory unit is in the form of a ring memory.

10. The device as claimed in claim 5,
wherein the central computer unit is in the form of a personal computer via a HART, PROFIBUS or FOUNDATION field bus protocol.

11. The device as claimed in claim 6,
wherein the central computer unit is in the form of a personal computer via a HART, PROFIBUS or FOUNDATION field bus protocol.
